(19) United States
(12) Patent Application Publication
(10) Pub. No.: US 2011/0084598 A1
(43) Pub. Date: Apr. 14, 2011

(54) Carbonitride Phosphor, Preparation Method and Light Emitting Device Thereof

(75) Inventors: Teng-Ming Chen, Hsinchu City (TW); Yun-Chen Wu, Taipei City (TW); Chuang-Hung Chiu, Hsinchu County (TW); Huai-An Li, Jhongli City (TW); Chi-Neng Mo, Jhongli City (TW)

(73) Assignee: CHUNGHWA PICTURE TUBES, LTD., Taoyuan (TW)

(21) Appl. No.: 12/690,561

(22) Filed: Jan. 20, 2010

(30) Foreign Application Priority Data
Oct. 9, 2009 (TW) 098134308

(51) Int. Cl. H01J 1/62; C09K 11/77

(52) U.S. Cl. 313/504; 252/301.4 R

(57) ABSTRACT

A carbonitride phosphor is provided, which is represented by a general chemical formula of (M_{1-x-y}NₓCe_{y})₂(CN₂)₃, in which 0.005≦x≦0.20, 0.005≦y≦0.15, and M and N are respectively selected from a group consisting of yttrium, lanthanum, cerium, praseodymium, neodymium, samarium, gadolinium, terbium, dysprosium, holmium, erbium, thulium, ytterbium and cassiopeium.

### CROSS-REFERENCE TO RELATED APPLICATION

This application claims the benefit of Taiwan Patent Application No. 098134308, filed on Oct. 9, 2009, which is hereby incorporated by reference for all purposes as if fully set forth herein.

### BACKGROUND OF THE INVENTION

1. Field of Invention

The present invention relates to a phosphor, and particularly to a carbonitride phosphor.

2. Related Art

Light emitting diode (LED) products have advantages such as long life-span, energy saving, durability, vibration resistance, reliability, suitability for large-scale production, small volume, and rapid response, and are common light emitting elements in daily life appliances.

Now, yttrium aluminum garnet (YAG) yellow phosphor, developed by Nichia Corporation, is a commonly available white-conversion phosphor in the market, in which a desired white light is mainly generated by exciting the YAG yellow phosphor by a blue LED to generate a yellow light of 555 nm that is complementary to blue light, and then mixing the complementary yellow and blue lights using the lens principle.

However, the YAG phosphor is an oxide phosphor, which can easily react with moisture in air and is not so stable at high temperature. Therefore, there is an urgent need for a non-oxide phosphor in the industry, which also can be efficiently combined with other phosphors for use in LEDs.

### SUMMARY OF THE INVENTION

The present invention is directed to a carbonitride phosphor, which is a non-oxide phosphor and is applicable in LEDs.

The present invention provides a carbonitride phosphor, applicable in light emitting diodes (LEDs), and represented by a general chemical formula of (M_{1-x-y}NₓCe_{y})₂(CN₂)₃, wherein 0.005≦x≦0.20 and 0.005≦y≦0.15, wherein M is selected from a group consisting of yttrium, lanthanum, cerium, praseodymium, neodymium, samarium, gadolinium, terbium (Tb), dysprosium, holmium, erbium, thulium, ytterbium and cassiopeium, and wherein N is selected from a group consisting of yttrium, lanthanum, cerium, praseodymium, neodymium, samarium, gadolinium, terbium, dysprosium, holmium, erbium, thulium, ytterbium and cassiopeium.

In one embodiment, the carbonitride phosphor is (Y_{0.97}Ce_{0.03})₂(CN₂)₃.

In one embodiment, the carbonitride phosphor is (Y_{0.965}Gd_{0.005}Ce_{0.03})₂(CN₂)₃.

In one embodiment, the carbonitride phosphor has an excitation wavelength between 240 nm and 480 nm.

In one embodiment, the carbonitride phosphor has a chromaticity coordinate of (0.48, 0.47).

In one embodiment, the carbonitride phosphor has a main emission wavelength of 550 nm.

The present invention is also directed to a method for preparing the carbonitride phosphor. The method for preparing a carbonitride phosphor comprises the steps of: weighting stoichiometric amounts of a MF₃ or a MCl₃, an alkaline metal carbonitride or an alkaline earth metal carbonitride, and cerium fluoride (CeF₃) or cerium chloride (CeCl₃), wherein M is selected from a group consisting of yttrium, lanthanum, cerium, praseodymium, neodymium, samarium, gadolinium, terbium, dysprosium, holmium, erbium, thulium, ytterbium, and cassiopeium; uniformly mixing the compounds above and then grinding; and placing it in a crucible, and then transferring the crucible to a high temperature oven for sintering.

In one embodiment, a grinding time of the grinding is 10 to 30 min.

In one embodiment, a sintering temperature of the high temperature oven is 600 to 800° C.

In one embodiment, a sintering time of the sintering is 6 to 12 h.

In one embodiment, the sintering is carried out under a reduction atmosphere.

In one embodiment, the crucible is an alumina crucible.

The present invention is further directed to a light emitting device. The light emitting device, comprises an LED chip, and a photoluminescence phosphor layer, formed with the carbonitride phosphor according to claim 1, and arranged on the LED chip, wherein the photoluminescence phosphor layer absorbs at least a part of a light emitted by the LED chip, and emits a light having a wavelength different from that of the absorbed light.

In one embodiment, the LED chip has an emission spectrum with a main peak between 360 nm and 560 nm.

In one embodiment, the LED chip is a blue or purple LED chip.

As embodied and broadly described herein, the carbonitride phosphor provided by the present invention is a non-oxide phosphor and can also be efficiently combined with other phosphors for use in LEDs.

In order to make the content of the present invention more comprehensible, the embodiments of the present invention are described below with reference to the accompanying drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 shows an X-ray diffraction spectrum of (Y_{0.97}Ce_{0.03})₂(CN₂)₃;

FIG. 2 shows an X-ray diffraction spectrum of (Y_{0.965}Gd_{0.005}Ce_{0.03})₂(CN₂)₃;

FIG. 3 shows an excitation spectrum of (Y_{0.97}Ce_{0.03})₂(CN₂)₃;

FIG. 4 shows a relationship between an emission intensity of (Y_{0.97}Ce_{0.03})₂(CN₂)₃ and a concentration of Ce³⁺ ion; and

FIG. 5 shows a chromaticity coordinate diagram of (Y_{0.97}Ce_{0.03})₂(CN₂)₃.

### DETAILED DESCRIPTION OF THE INVENTION

The present invention provides a carbonitride phosphor, which can be represented by a general chemical formula of (M_{1-x-y}NₓCe_{y})₂(CN₂)₃, in which 0.005≦x≦0.20, 0.005≦y≦0.15, and M and N are respectively selected from a group consisting of yttrium (Y), lanthanum (La), cerium (Ce), praseodymium (Pr), neodymium (Nd), samarium (Sm), gadolinium (Gd), terbium (Tb), dysprosium (Dy), holmium (Ho), erbium (Er), thulium (Tm), ytterbium (Yb), and cassiopeium (Lu).

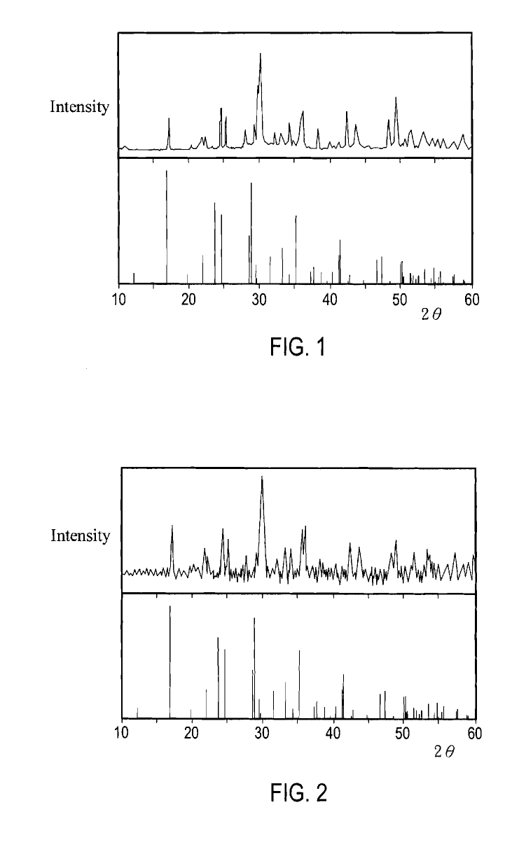

For example, the carbonitride phosphor of the present invention can have a general chemical formula of (Y_{0.97}Ce_{0.03})₂(CN₂)₃ or (Y_{0.965}Gd_{0.005}Ce_{0.03})₂(CN₂)₃. Referring to FIGS. 1 and 2, FIG. 1 shows an X-ray diffraction spectrum of (Y_{0.97}Ce_{0.03})₂(CN₂)₃, and FIG. 2 shows an X-ray diffraction spectrum of (Y_{0.965}Gd_{0.005}Ce_{0.03})₂(CN₂)₃. Constituent phases and compositions of the carbonitride phosphors can be identified from these X-ray diffraction spectra.

The carbonitride phosphor of the present invention is mainly prepared by high temperature solid-state method in combination with weak reduction condition, and preparation methods thereof are described below by way of example; however, the present invention is not limited thereto.

A method for preparing the carbonitride phosphor of the present invention includes:

weighting stoichiometric amounts of a MF₃ or a MCl₃, an alkaline metal carbonitride or an alkaline earth metal carbonitride, and cerium fluoride (CeF₃) or cerium chloride (CeCl₃), where M is selected from a group consisting of yttrium, lanthanum, cerium, praseodymium, neodymium, samarium, gadolinium, terbium, dysprosium, holmium, erbium, thulium, ytterbium and cassiopeium; uniformly mixing the compounds above and then grinding for 10 to 30 min; and

placing the ground powder in an alumina crucible and then transferring it to a high temperature oven for sintering at 600 to 800° C. under a reduction atmosphere for 6 to 12. It is noted that the reduction atmosphere means an atmosphere of hydrogen, a mixture of hydrogen and nitrogen, or a mixture of hydrogen and argon.

The carbonitride phosphor of the present invention can be used as a photoluminescence phosphor in a light emitting device. The light emitting device includes: an LED chip and a photoluminescence phosphor layer. The photoluminescence phosphor layer is formed with the carbonitride phosphor described above, and arranged on the LED chip, where the photoluminescence phosphor layer will absorb at least a part of a light emitted by the LED chip, and emit a light having a wavelength different from that of the absorbed light.

It is noted that the LED chip above has an emission spectrum with a main peak between 360 nm and 560 nm, or is a blue or purple LED chip. The arrangement of the carbonitride phosphor of the present invention on the LED chip allows the complementary yellow and blue lights to be mixed, to produce a desired white light, and therefore, the carbonitride phosphor of the present invention is applicable in LEDs, and especially white LEDs.

Furthermore, in order to achieve a better photochromic effect, the carbonitride phosphor of the present invention also can be used in combination with other red phosphor, blue phosphor, or green phosphor.

Hereinafter, the present invention will be described with (Y_{0.97}Ce_{0.03})₂(CN₂)₃ as an embodiment.

The preparation of (Y_{0.97}Ce_{0.03})₂(CN₂)₃ includes: weighting stoichiometric amounts of YF₃ (or YCl₃), Li₂CN₂ and CeF₃ (or CeCl₃), uniformly mixing, grinding for 10 to 30 min, then placing the resulting powder in a double alumina crucible with graphite powder contained in an outer crucible and sintering for 6-12 h at 600-800° C. under a reduction atmosphere, to produce a fluorescent material having a chemical composition of (Y_{0.97}Ce_{0.03})₂(CN₂)₃, which is then subjected to a fluorescence spectrum analysis and a chromaticity coordinate measurement. The steps above are repeated to find out a composition of an optimal concentration of Ce³⁺ ion.

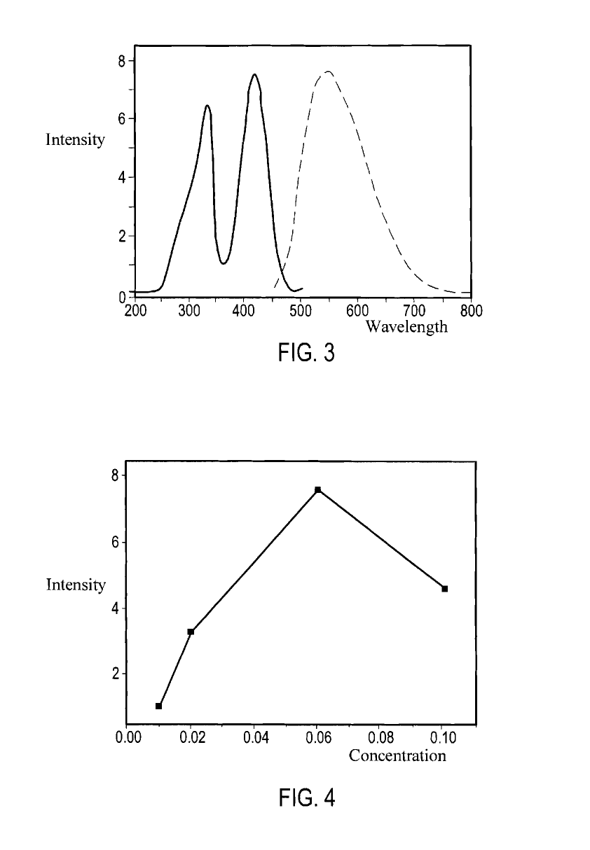

Referring to FIG. 3, FIG. 3 shows an excitation spectrum of (Y_{0.97}Ce_{0.03})₂(CN₂)₃; an excitation wavelength of the carbonitride phosphor is between 240 nm to 480 nm, in which two wave bands having better excitation are respectively a wavelength of 335±10 nm and a wavelength of 410±10 nm, and a main emission wavelength of (Y_{0.97}Ce_{0.03})₂(CN₂)₃ is 550 nm.

Referring to FIG. 4, FIG. 4 shows a relationship between an emission intensity of (Y_{0.97}Ce_{0.03})₂(CN₂)₃ and a concentration of Ce³⁺ ion; it is known from FIG. 4 that (Y_{0.97}Ce_{0.03})₂(CN₂)₃ has a better emission intensity when the concentration of Ce³⁺ ion is 3 mol %.

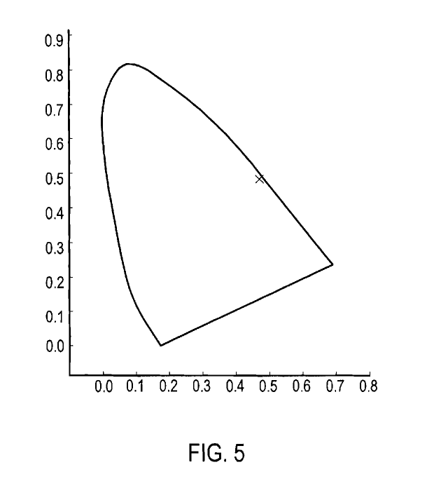

Referring to FIG. 5, FIG. 5 shows a chromaticity coordinate diagram of (Y_{0.97}Ce_{0.03})₂(CN₂)₃ of (0.48, 0.47), which is a chromaticity value from a yellow light.

In summary, the carbonitride phosphor of the present invention, as a non-oxide phosphor, has a stronger covalence than a pure oxide, is stable at high temperature, and also can be efficiently combined with other phosphors for use in LEDs.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A carbonitride phosphor, applicable in light emitting diodes (LEDs), and represented by a general chemical formula of (M_{1-x-y}NₓCe_{y})₂(CN₂)₃, wherein 0.005≦x≦0.20 and 0.005≦y≦0.15;
wherein M is selected from a group consisting of yttrium, lanthanum, cerium, praseodymium, neodymium, samarium, gadolinium, terbium (Tb), dysprosium, holmium, erbium, thulium, ytterbium and cassiopeium; and
wherein N is selected from a group consisting of yttrium, lanthanum, cerium, praseodymium, neodymium, samarium, gadolinium, terbium, dysprosium, holmium, erbium, thulium, ytterbium and cassiopeium.

2. The carbonitride phosphor according to claim 1, wherein the carbonitride phosphor is (Y_{0.97}Ce_{0.03})₂(CN₂)₃.

3. The carbonitride phosphor according to claim 1, wherein the carbonitride phosphor is (Y_{0.965}Gd_{0.005}Ce_{0.03})₂(CN₂)₃.

4. The carbonitride phosphor according to claim 1, wherein the carbonitride phosphor has an excitation wavelength between 240 nm and 480 nm.

5. The carbonitride phosphor according to claim 1, wherein the carbonitride phosphor has a chromaticity coordinate of (0.48, 0.47).

6. The carbonitride phosphor according to claim 1, wherein the carbonitride phosphor has a main emission wavelength of 550 nm.

7. A method for preparing a carbonitride phosphor according to claim 1, comprising:
weighting stoichiometric amounts of a MF₃ or a MCl₃, an alkaline metal carbonitride or an alkaline earth metal carbonitride, and cerium fluoride (CeF₃) or cerium chloride (CeCl₃), wherein M is selected from a group consisting of yttrium, lanthanum, cerium, praseodymium, neodymium, samarium, gadolinium, terbium, dysprosium, holmium, erbium, thulium, ytterbium, and cassiopeium;
mixing the compounds above and then grinding; and
placing it in a crucible, and then transferring the crucible to a high temperature oven for sintering.

8. The method according to claim 7, wherein a grinding time of the grinding is 10 to 30 min.

9. The method according to claim 7, wherein a sintering temperature of the high temperature oven is 600 to 800° C.

10. The method according to claim 7, wherein a sintering time of the sintering is 6 to 12 h.

11. The method according to claim 7, wherein the sintering is carried out under a reduction atmosphere.

12. The method according to claim 7, wherein the crucible is an alumina crucible.

13. A light emitting device, comprising:
an LED chip; and
a photoluminescence phosphor layer, formed with the carbonitride phosphor according to claim 1, and arranged on the LED chip, wherein the photoluminescence phosphor layer absorbs at least a part of a light emitted by the LED chip, and emits a light having a wavelength different from that of the absorbed light.

14. The light emitting device according to claim 13, wherein the LED chip has an emission spectrum with a main peak between 360 nm and 560 nm.

15. The light emitting device according to claim 13, wherein the LED chip is a blue LED chip or a purple LED chip.
